(19) United States
(12) Patent Application Publication
(10) Pub. No.: US 2025/0331073 A1
(43) Pub. Date: Oct. 23, 2025

(54) INDUCTION COOKTOP AND SYSTEM OF AN INDUCTION COOKTOP WITH A WORK SURFACE

(71) Applicant: E.G.O. Elektro-Gerätebau GmbH, Oberderdingen (DE)

(72) Inventors: Thomas Föller, Schwaigern (DE); Raphael Fricker, Pforzheim (DE)

(21) Appl. No.: 19/175,201

(22) Filed: Apr. 10, 2025

(30) Foreign Application Priority Data
Apr. 23, 2024 (DE) 10 2024 111 402.9

(51) Int. Cl. H05B 6/12; H01F 27/29; H02J 50/00; H02J 50/10; H02J 50/40

(52) U.S. Cl. CPC H05B 6/1236; H02J 50/005; H02J 50/10; H02J 50/40; H01F 27/29; H05B 2213/05

(57) ABSTRACT

The invention relates to an induction cooktop that has internal induction heating coils for inductively heating an item of cookware and at least one external induction coil for inductive power transfer to an electrical consumer, at least one power module including converter for supplying power to the induction heating coils and the external induction coil, as well as a cooktop controller. It also has a cooktop plate, an operating means thereunder, a supply connection for supplying energy to the induction cooktop from the outside and a cooktop housing. The induction heating coils are arranged within the induction cooktop and beneath the cooktop plate. Connected to the power module there is a connecting lead to which the external induction coil is connected for it to be supplied with power by the power module. The external induction coil is configured to be installed spatially separately from the induction cooktop outside the induction cooktop and is configured for inductive power transfer to an electrical consumer that has a receiver coil that is inductively couplable with the external induction coil.

### CROSS-REFERENCE TO RELATED APPLICATIONS

This application claims priority to DE Application No. DE 102024111402.9, filed Apr. 23, 2024, entitled “Induction Cooktop And System Of An Induction Cooktop With A Work Surface,” the entirety of which is hereby incorporated by reference.

### FIELD OF APPLICATION AND PRIOR ART

The invention relates to an induction cooktop and to a system having such an induction cooktop and a work surface. The induction cooktop also serves to effect an inductive power transfer, or wireless power transfer (WPT), to an electrical consumer such as a food processor or the like that supplies electricity or electrical energy to the electrical consumer for the operation thereof, see for example U.S. Pat. No. 11,699,924 B1. Such an inductive power transfer can advantageously be carried out according to the Ki standard.

### OBJECT AND SOLUTION

The object of the present invention is to provide an induction cooktop as stated above and a stated system for operating such an induction cooktop, with which prior art problems can be avoided and it is in particular possible to enable operation of the induction cooktop together with an inductive power transfer to an electrical consumer.

This object is achieved by an induction cooktop as stated above having the features of claim 1 and by a system having the features of claim 19. Advantageous and preferred embodiments of the invention are the subject matter of further claims and are explained in greater detail below. Some of the features are described only for the induction cooktop or only for the system. However, irrespectively, they are intended to apply separately and mutually independently both to the induction cooktop and to the system. The wording of the claims is incorporated by express reference into the content of the description.

The induction cooktop has at least one induction heating coil for inductively heating an item of cookware arranged thereabove, advantageously configured as is conventional for inductive heating and possibly also with a secondary function for inductive power transfer. It has at least one external induction coil for inductive power transfer to an electrical consumer, advantageously according to the Ki standard, or is at least configured for connection and subsequent operation of such an external induction coil. The induction cooktop then controls the operation of the external induction coil with an operating means that it has. At least one power module including converter is provided for supplying power to the at least one induction heating coil and the at least one external induction coil, advantageously divided into a plurality of modules. It furthermore has a cooktop controller and a cooktop plate, on or under which is arranged the operating means. The induction heating coils are also arranged under the cooktop plate. The induction cooktop also has a supply connection for supplying energy to the induction cooktop from the outside and at least one cooktop housing. The power module or power supply are arranged in this at least one or in each cooktop housing. The cooktop controller can also be arranged therein and possibly also the at least one induction heating coil, wherein the latter can also be arranged thereabove. The stated supply connection can be arranged on or in the cooktop housing, as advantageously can also be connections to the induction heating coils and/or the at least one external induction coil.

According to the invention, the at least one induction heating coil is arranged within the cooktop housing or within the induction cooktop, namely beneath the cooktop plate. The induction cooktop may be a single contiguous module, but may possibly also be divided into two or three modules that are then connected to one another by way of leads or the like. Connected to the power module there is at least one connecting lead to which the external induction coil is or can be connected for it to be supplied with power by the power module and the converter arranged therein. The at least one external induction coil is configured to be installed spatially separately from the induction cooktop, i.e., outside the cooktop housing or the induction cooktop. It is configured for inductive power transfer, for example according to the WPT or Ki standard, to an electrical consumer. This electrical consume has a receiver coil that is inductively couplable with the external induction coil. Such an electrical consumer may be a kitchen appliance, a mixer or a small item of electrical equipment.

The external arrangement of the induction coil means that it can be positioned away from the induction cooktop and appropriately to its particular installation situation. It can be exactly adapted to the induction cooktop and configured to operate with its power supply and, especially, also above its operating means. As a result, the external induction coil does not require its own power supply or operating means, so considerably reducing component costs and installation effort. The induction cooktop can be assembled, sold and installed in direct combination with the connected external induction coil. Alternatively, the external induction coil may be produced and sold by the same manufacturer as the induction cooktop but possibly in different configurations and above all also only optionally, i.e., if directly desired by the purchaser of the induction cooktop. The external induction coil can possibly also be retrofitted, in which case electrical connection to the induction cooktop is straightforwardly possible. The induction heating coils and the external induction coil may be similarly configured, possibly even partially or completely identically. They can each also perform the other function but are in themselves optimized either for inductive heating or for inductive power transfer.

In one development of the invention, a further additional connection can be provided on the power module in addition to connections for the at least one built-in induction heating coil. This additional connection is configured for electrical connection to the connecting lead, wherein the connecting lead connected thereto is routed out of the cooktop housing or protrudes or departs therefrom. A voltage converted by the power module or converter is applied to the additional connection and can be used to provide a direct supply to the external induction coil.

In a further development of the invention, the connecting lead may be detachably connected to the additional connection, i.e., to the induction cooktop, for which purpose a plug connection or a screw connection may preferably be used. Replacement or length adjustment may then be possible. Alternatively, it can be nondetachably connected to the additional connection, such that the connection has already been made during installation. An electrical connection of the connecting lead to the external induction coil may be configured in the same way.

Provision may also be made for as many connections to be provided on the power module or for exactly as many connections to be provided as there are induction heating coils that are or may be arranged in the induction cooktop. One of these induction heating coils is eliminated, i.e., not even installed, and the connecting lead for the external induction coil is connected to its electrical connection. Again, the connections may take the form of a plug connection or a screw connection.

In a further development of the invention, the cooktop controller may be configured to use the power supply to drive the external induction coil for inductive power transfer to the electrical consumer in such a way that a power request from the electrical consumer is transferred via the inductive coupling between receiver coil and external induction coil to the power module and to the cooktop controller where the power request is converted into the desired inductive power transfer to the electrical consumer by way of the external induction coil. The external induction coil then generates exactly the power required and requested by the electrical consumer.

The external induction coil for inductive power transfer to the electrical consumer is advantageously arranged in a separate coil housing from the cooktop housing, i.e., in its own housing. In this coil housing, ferrite bodies can be arranged beneath the induction coil for magnetic field guidance as is known per se. Further per se known parts may be provided thereon. The advantage of a separate coil housing is also that the external induction coil is then electrically insulated and can be easily assembled, for example using fastening portions.

The stated coil housing should have no operating means or have no operating means of its own, i.e., in particular no operating elements, and preferably also no display.

The coil housing may have provided thereon or therein an electrical connection means for the connecting lead, wherein the external induction coil may be connected to the electrical connection means for inductive power transfer using a stranded coil wire. It may advantageously be fixedly connected. The connecting lead may be detachably connected to the electrical connection means, in particular as a plug connection or a screw connection. This makes it quick and easy to establish an electrical connection.

In a further development of the invention, a connecting lead fixedly and nondetachably connected to the external induction coil may lead away from the coil housing. This connecting lead may be or have an extended stranded coil wire of the external induction coil. A free end of the connecting lead can be configured to establish an electrical connection that may in particular take the form of a plug connection or a screw connection.

Provision may be made for the external induction coil to have a detection function or for a sensor means to be arranged thereon, which function or means is permanently enabled so as to detect the electrical consumer being set down in order to be inductively supplied with power. The induction cooktop also need not itself be switched on or enabled for this purpose, the external induction coil then being capable of doing this in order to be operated therewith. A microcontroller may possibly be arranged in the above-stated coil housing in order to evaluate sensors on the external induction coil in order to detect the electrical consumer being set down or the like.

In one development of the invention, the connecting lead may be a multicore connecting lead, wherein it preferably has two conductors for transferring power that are thick enough for the expected power that is to be transferred. There may also be two or three conductors for transferring data or signals or auxiliary voltages, for example in order to process signals from a temperature sensor directly at the external induction coil. Subsequent signal transfer is then less susceptible to interference.

In one development of the invention, at least one switching means, preferably a relay or power semiconductor switch, may be provided in the power module in order to connect a converted voltage from the converter either to a connected induction heating coil in the cooktop housing or to the connected external induction coil that is itself arranged externally.

In a further development of the invention, two connecting leads can be routed out of the cooktop housing in order to be able to connect two, and possibly even more, such external induction coils for inductive power transfer. Preferably, exactly one single connecting lead is provided per connectable external induction coil.

An induction cooktop may have two to six induction heating coils that can occupy at least 30% of the area available next to the cooktop controller. This percentage may preferably be 40% to 80%. The induction heating coils can thus occupy a significant or even predominant part of the area.

In a further development of the invention, the external induction coil may also be configured for inductively heating cooking vessels arranged thereabove, and may also be driven accordingly. In this case, they and the internal induction heating coils are driven in a manner that does not fundamentally differ. Accordingly, provision may also be made for at least one of the induction heating coils to be configured for inductive power transfer to the electrical consumer. The latter may be configured like the external induction coil, advantageously likewise according to the Ki standard.

The induction cooktop may advantageously have two cooktop housings, preferably with a single common cooktop plate, or alternatively also with two or more cooktop plates, but as a single appliance. Each cooktop housing may have a power module including converter, preferably exactly one power module or exactly two power modules.

In a first development of the invention, only induction heating coils may be arranged in or on one of two cooktop housings without a connection option for the external induction coil. A previously described additional connection for the external induction coil is then provided in the other cooktop housing.

An above-described induction cooktop and a work surface are provided in a system according to the invention, wherein the induction cooktop is arranged on the work surface, in particular inserted into a cutout. The induction cooktop has a cooktop plate for placing cookware or the like for inductive heating, as is known per se. The at least one external induction coil is arranged under this work surface or under a further work surface of the system, wherein said coil is connected to the induction cooktop by way of the connecting lead.

The connecting lead is advantageously the only electrical and/or signal transfer connection of the external induction coil to the outside or to the induction cooktop. The external induction coil should not have integrated power conversion as this takes place more efficiently in the induction cooktop itself and in its power module.

In a further development of the invention, the external induction coil can be arranged in the above-described coil housing, wherein this coil housing is fastened, in particular detachably fastened, to the work surface from below. The work surface above the coil housing and thus above the external induction coil preferably has a lesser thickness in a recessed region than in the other regions. It is in particular mechanically thinned by way of a blind hole or the like, wherein the coil housing extends into this recessed region.

In the region in which the external induction coil is arranged, the work surface may have a thickness of at most 12 mm, preferably of between 1 mm and 8 mm. It advantageously consists of material that is permeable to magnetic fields. Such materials are known. The external induction coil should advantageously be arranged plane-parallel to the work surface under which it is fastened.

In a further development of the invention, the connecting lead can be routed from the power module to a connection box arranged outside the cooktop housing, wherein said lead is electrically connected to said box. An electrical connection may be established via screw terminals or a plug connection. At least one external induction coil for inductive power transfer can be connected to this connection box, wherein said coil may preferably be fastened to a support plate of the induction cooktop, i.e., as part of the appliance, or directly to the work surface.

A channel for the connecting lead may advantageously be provided, in particular milled into, the work surface. The connecting lead may run within the channel and not protrude from the channel or work surface in the installed state. It should preferably be fastened in the channel, in particular by adhesive bonding, clamps, or other securing means. This may be achieved by firstly milling a channel, into which the connecting lead is inserted and fastened, in the work surface. This means that there is no need to make recesses in base units, drawers etc., and the connecting lead could also be laid above a dishwasher or the like without any problem. No additional fastening of the lead is necessary.

These and further features are revealed in the description and in the drawings as well as in the claims, wherein the individual features can be realized singly or severally in the form of subcombinations in one embodiment of the invention and in other fields, and can constitute advantageous embodiments eligible for protection in themselves, for which protection is here sought. The subdivision of the application into individual sections and subheadings does not limit the statements made thereunder in their general validity.

### BRIEF DESCRIPTION OF THE DRAWINGS

Further advantages and aspects of the invention can be found in the claims and in the description of exemplary embodiments of the invention that are explained in the following on the basis of the figures. In the drawings:

FIG. 1 shows an a oblique view of a system according to the invention with a work surface on which is arranged an induction cooktop according to the invention with an induction coil for inductive power transfer arranged outside or externally thereof,

FIG. 2 shows a variant of the illustration in FIG. 1 with the cooktop plate removed for clarity and an electrical consumer above the external induction coil in order to be supplied with power,

FIG. 3 is a view of the system of FIG. 1 from below, wherein the external induction coil is connected to the induction cooktop with a continuous connecting lead,

FIG. 4 shows a variant of FIG. 3, in which the external induction coil with an interrupted connecting lead is connected to a connection box fastened to the underside of the work surface,

FIG. 5 is an illustration of an induction cooktop according to the invention with two cooktop housings, a plurality of internal induction heating coils and an external induction coil arranged outside thereof,

FIG. 6 is the illustration from FIG. 5 with a support plate between the cooktop housings and the induction heating coils and with an additional induction heating coil that can be driven alternately with the external induction coil,

FIG. 7 is a bottom view of a variant of an induction cooktop according to the invention with details regarding the connection of the external induction coil,

FIG. 8 shows a further variant of a system according to the invention similar to FIG. 3 with a plurality of connecting plugs for a plurality of external induction coils, to each of which can be connected an external induction coil,

FIG. 9 shows a further variant of a system according to the invention with an induction cooktop with two cooktop housings, wherein each of them is connected to an external induction coil for inductive power transfer, and

FIG. 10 is an enlarged, partially sectional illustration of an external induction coil for inductive power transfer in its own coil housing.

### DETAILED DESCRIPTION OF THE EXEMPLARY EMBODIMENTS

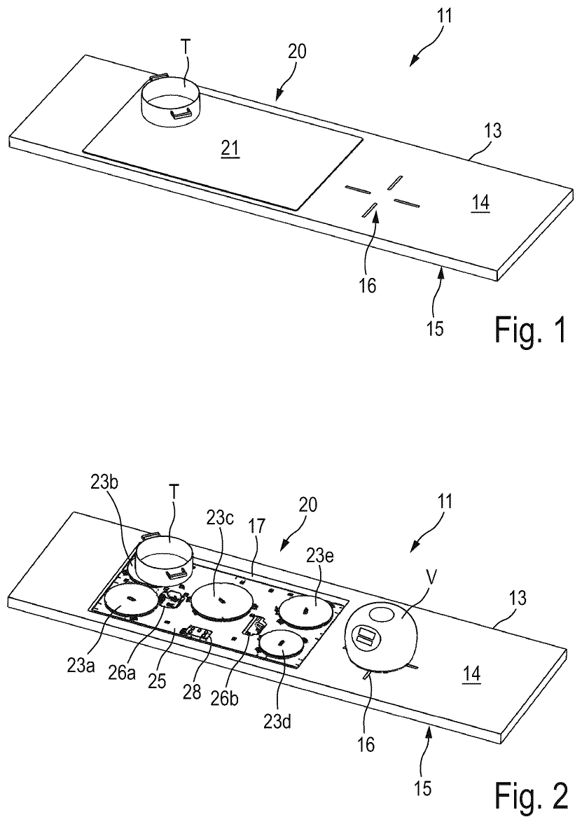

FIG. 1 shows a system according to the invention 11 consisting of a work surface 13 and an induction cooktop 20 according to the invention. The work surface 13 has an upper side 14 on which is provided a marking 16 somewhat to the right next to the induction cooktop 20. As shown in FIG. 2, this is where an electrical consumer V as explained above, for example a mixer or a food processor, can be set down and operated or inductively supplied with energy. Such inductive power transfer may advantageously be carried out according to the Ki standard, see for example U.S. Pat. No. 11,699,924 B1. A pan T is placed for inductive heating in known manner on a cooktop plate 21 of the induction cooktop 20.

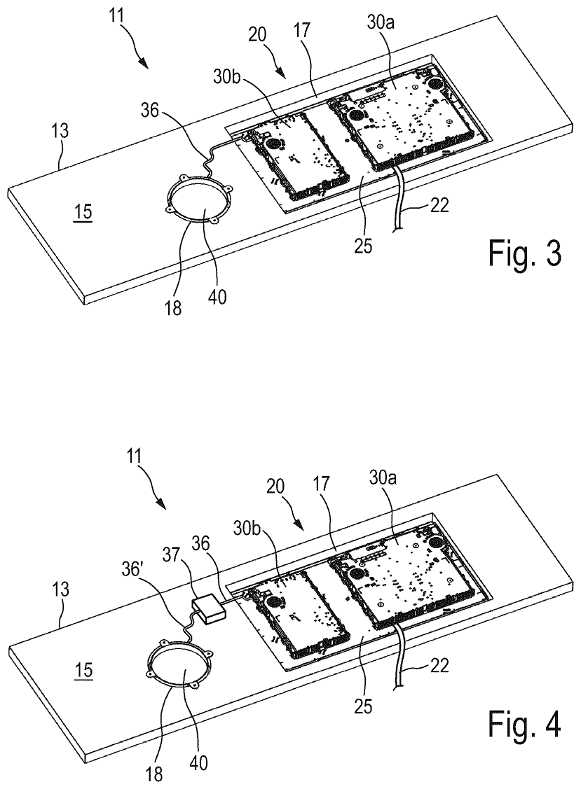

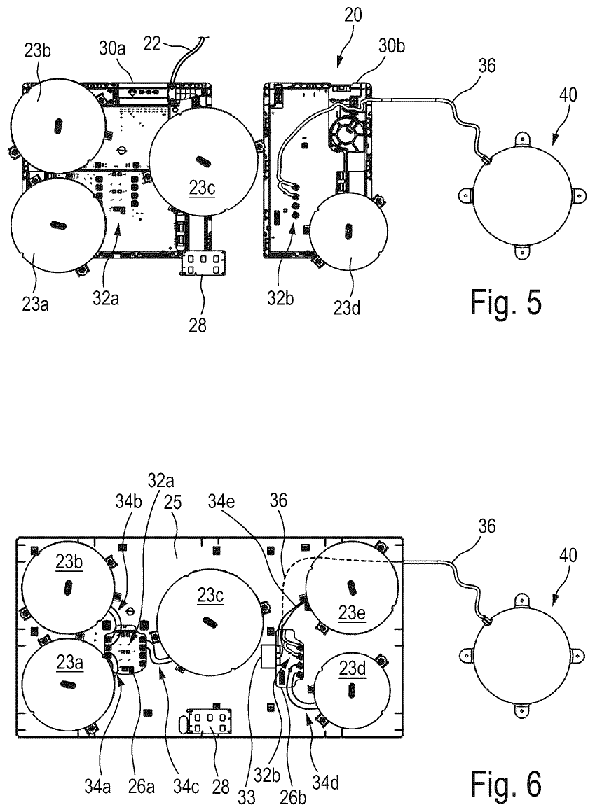

The illustration of the system 11 according to FIG. 2 shows that the cooktop plate 21 has been removed from the induction cooktop 20 and the interior of the induction cooktop 20 is as it were somewhat more visible. It can be seen that a continuous rectangular cutout 17 is provided, in particular sawn or milled, in the work surface 13. The induction cooktop 20 is inserted into the opening or cutout 17, see also the illustration of the same system 11 from below in FIG. 3. The induction cooktop 20 in this case has five induction heating coils 23a to 23e that are arranged on a “support plate” 25. They are mainly configured or optimized for operation for inductive heating. The support plate 25 has two connection openings 26a and 26b through which the induction heating coils 23a to 23e arranged closest thereto can be electrically connected in known manner. One such connection relates both to two conductors for electrical power supply and to two or more signal leads for temperature sensors that are arranged on top of the induction heating coils 23. Reference is made to FIGS. 5 and 6 in this respect.

An operating means 28 is arranged on the support plate 25 in front of the central induction heating coil 23c. It may likewise be configured in known manner, in particular with illuminated displays, capacitive operating elements and a necessary cooktop controller, in particular formed by a microcontroller.

FIG. 3 shows the system 11 according to the invention with the work surface 13 and induction cooktop 20 according to the invention from below. The cutout 17 and recess 18 in the work surface 13 are clearly visible here. The recess 18 takes the form of a blind hole, the work surface 13 thus having a distinctly reduced thickness here too. This reduced thickness is advantageously between 3 mm and 8 mm, the work surface 13 otherwise having a thickness of 15 mm to 25 mm in the case of stone and a good 35 mm or more in the case of wood or particle board or the like.

The induction cooktop 20 has two cooktop housings 30a and 30b on an underside of the support plate 25, wherein the cooktop housing 30b is visibly smaller. A power module including converter for supplying power to the three induction heating coils 23a to 23c is arranged in the larger cooktop housing 30a. A single common cooktop housing could also be provided. Similarly, the cooktop plate 21 could also be divided into two, for example with a downdraft extractor therebetween.

The external induction coil 40 is inserted into the previously described recess 18 and protrudes into it. It can be fastened in various ways, advantageously tightly screwed in place. A continuous connecting lead 36 that connects the external induction coil 40 to the induction cooktop 20 or to the smaller cooktop housing 30b is clearly visible. The connecting lead 36 may advantageously be fastened to the underside 15 of the work surface 13, for example by way of cable clips or adhesive. Alternatively, a kind of cable channel can be milled into the underside 15 in a similar way to the recess 18, whereby, similarly to the external induction coil 40, no part protrudes beyond the underside 15. It is then possible to install the work surface 13 above base units or other electrical appliances without any problem.

FIG. 4 shows an alternative electrical connection for the external induction coil 40 to the cooktop housing 30b. A connecting lead 36 again departs from the cooktop housing 30b but instead goes to a connection box 37. This connection box 37 is fastened to the underside 15 of the work surface 13. Similarly to what is known for electrical leads, this may be a type of junction box and advantageously have screw or clamp connections on the inside, or alternatively also plug connections. A further connecting lead 36′ comes from the external induction coil 40 and is connected in the connection box 37 to the connecting lead 36 in the manner provided there. This may possibly simplify electrical connection of the external induction coil 40. It may further be provided that the connecting lead 36′ is fixedly attached to the external induction coil 40, in particular with a stranded coil wire that is directly routed onward. It may have a predetermined length of for example 60 cm or 100 cm. If the external induction coil 40 is provided close enough to the induction cooktop 20 or to the connections 32 for this connecting lead 36′ to be sufficiently long, it can be connected directly to these connections 32. If, on the other hand, it is to be provided further away than the length of the connecting lead 36′ allows, it is possible to provide such a connection box 37 together with an additional connecting lead 36. This connecting lead 36 can then take the form of a relatively simple cable and have two conductors of thicker cross-section for power transfer and further above-stated conductors for data or signals and auxiliary voltages. This additional connecting lead 36 may be supplied in various prefabricated lengths, such that it can have been or can be connected at one end to the connections 32b of the cooktop housing 30b. The other end can have been connected or can be connected to connections of the connection box 37. Length adjustment is therefore possible. Under certain circumstances, an appropriate recess for the connection box 37 can also be created in the underside 15 of the work surface 13.

According to FIG. 5, the power modules in the cooktop housings 30 have identifiable connections 32a, advantageously on a component carrier or a printed circuit board, the side of which, not visible in FIG. 5, may have further electronic or electrical components arranged on it. The connections 32a advantageously take the form of conventional screw terminals for induction heating coils. Connecting cables 34a to 34c that depart from the induction heating coils 23a to 23c can be connected here as shown in FIG. 6. These connecting cables advantageously consist of an onwardly routed stranded coil wire from the respective induction heating coil 23. These have had the insulation stripped from their ends and are accordingly provided with conductive end regions in order to connect them to the connections 32a with good contact. Data cables or data leads, such as for the temperature sensors, that may be present in the stated connecting cables 34 and go to separate connectors, advantageously to plug connectors, are not shown. However, this is in each case known from the prior art.

Connections 32b, which are in principle configured identically to the connections 32a, are provided above the smaller cooktop housing 30b. According to FIG. 6, the induction heating coil 23d is connected to two of these connections 32b by way of a connecting cable 34d. An induction heating coil 23e provided at the back right is connected via a connecting cable 34e.

It is apparent from this that the power module including converter in the cooktop housing 30a is larger and more powerful than that in the cooktop housing 30b. A power module including converter may for example be configured as a “dual module”, i.e., be used to supply power to two induction heating coils. Two such dual modules or alternatively a quadruple module are provided in the large cooktop housing 30a and just one such dual module in the cooktop housing 30b. This is also apparent in the view from below of FIGS. 3 and 4 from the provided fan openings, one of which is provided for each dual module.

The induction cooktop 20 is thus a single functional unit or appliance, but has two cooktop housings 30 and a plurality of power modules. A single supply connection 22 to the outside is provided for the induction cooktop 20. This may conventionally be a five-core cable fixedly installed in a house that is in this case connected to the larger cooktop housing 30a at a corresponding junction box. This is a three-phase connection for maximum power. Power is supplied to the smaller cooktop housing 30b by a connecting lead between the two cooktop housings 30a and 30b, wherein such a connection must in any event be provided since, for example, only a single operating means 28 is provided.

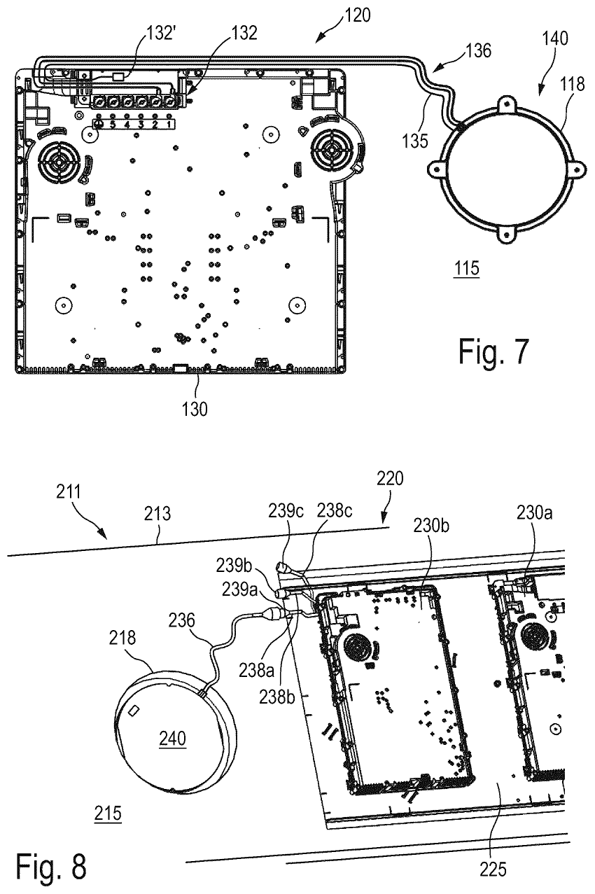

As FIG. 5 shows, the induction cooktop 20 there does not have an induction heating coil at the back right, unlike in the illustration in FIG. 2 and FIG. 6. A connecting lead 36 is connected to the upper two connections 32b, which lead runs out on the right from the cooktop housing 30b and leads to an external induction coil 40. The structure of this external induction coil 40 is explained below in greater detail with reference to FIG. 10. The connecting lead 36 may on the one hand be an extended stranded coil wire of the external induction coil 40, as previously described for the induction heating coils 23. In addition, the connecting lead 36 may also have additional conductors, which are also not shown here, with which data or signals or auxiliary voltages can be transferred. This serves to electrically connect sensors and for example control components or a microcontroller to the external induction coil 40. This is shown in FIG. 7, to which reference is made.

In the development of the induction cooktop 20 according to FIG. 5, the external induction coil 40 with its connecting lead 36 is fixedly connected to the upper two connections 32b in the cooktop housing 30b. It can thus be driven by a cooktop controller and the operating means 28 instead of the induction heating coil 23e according to FIGS. 2 and 6, which is not present in this case. The induction cooktop 20 then has four induction heating coils 23a to 23d as well as the external induction coil 40 with which the electrical consumer V according to FIG. 2 can be supplied with power or energy. Alternatively, the external induction coil 40 can also be driven such that pans T placed above it can be inductively heated. The external induction coil 40 then operates like one of the induction heating coils 23. However, as there is no temperature-resistant cooktop plate 21 above it, only the work surface 13, its power for inductive heating should be limited or certain temperatures should not be exceeded. As has been explained above, a temperature sensor 42 can advantageously also be provided in the external induction coil 40 as shown in FIG. 10. In a corresponding variant, one or more or each of the induction heating coils 23a to 23d may be configured for inductive power transfer according to a Ki standard or generally as WPT as explained above in addition to their function as inductive heating.

FIG. 6 shows an alternative development for the induction cooktop 20. In this case, there are six connections 32b in the small cooktop housing 30 beneath the connection opening 26b, two on the left and four on the right. The two induction heating coils 23d and 23e are each connected in the previously described manner by way of connecting cables 34d and 34e to two of these connections 32b, namely bottom right and left. The external induction coil 40 is connected by its connecting lead 36, which is shown partially dashed, to the final pair of connections 32b at the top right. All three coils, i.e., the two induction heating coils 23d and 23e and the external induction coil 40e, are thus permanently and fixedly connected to the induction cooktop 20. However, this will not work if only one power module including converter for two coils is provided in the corresponding cooktop housing 30b. For this reason, a relay switch 33, which could alternatively also take the form of a semiconductor switch, is provided in the cooktop housing 30b. This enables a cooktop controller either to drive the external induction coil 40 via the corresponding connections 32b at the top right or, for example, the rear induction heating coil 23e via the corresponding connections 32b on the left. In this solution, the corresponding dual module can operate either both induction heating coils 23d and 23e or just one of them and the external induction coil 40. This is irrelevant with regard to the above-stated data leads in the connecting lead 36 for the external induction coil 40, as largely any desired number of which leads can be connected to the induction cooktop 20. The advantage of this elevated component complexity is that, when the external induction coil 40 is not required, all five induction heating coils 23a to 23e are available and can each be used at full power.

FIG. 7 shows a somewhat differently configured induction cooktop 111 according to the invention from below in a fundamentally similar installation situation according to FIGS. 1 to 3. This induction cooktop 111, however, has just one single cooktop housing 130 that, due to its size and the two openings for fans, could be designed for a total of four induction heating coils. Advantageously, the power module has two dual modules, similarly to the previously described induction cooktop 11 in the larger cooktop housing 30a. In this case too, in addition to induction heating coils on the cooktop 111 that are not shown, an external induction coil 140 is provided that is connected to the cooktop housing 130 by way of a connecting cable 134. It is connected to connections 132 by two conductors of the connecting lead 136 that have a thicker cross-section and transfer the power from an converter or power module to the external induction coil 140. Furthermore, a separate signal cable 135 is provided that extends from the external induction coil 140 to a connector plug 132′ where it is plugged in. This connector plug 132′ is provided close to the connections 132.

Similarly to the description in relation to FIG. 6, the external induction coil 140 is in this case as it were a fifth coil of the induction cooktop 120. One of the other four induction heating coils can be driven alternately with the external induction coil 140, as has previously been described, advantageously by way of a relay switch. These four induction heating coils are electrically connected as shown in FIG. 6, i.e., by way of connecting cables and from above through connection openings in a support plate. Since this is no longer readily possible once the induction cooktop 120 has been installed in a stated system or on an underside 115 of a work surface, a connection option as shown in FIG. 7 can also be created. In this case, the external induction coil 140 can also be subsequently installed and connected. The connections 132 are obviously also readily accessible from the underside, i.e., in the installed state. Once connected, they can additionally be covered with a lid or the like. Further connections for generally electrically connecting the induction cooktop 120 to a power supply may also be provided in conventional manner in this region, for example by way of a previously described supply connection, i.e., a cable, that can be permanently installed in a house and can reach the connections.

FIG. 8 shows still another variant of a system 211 consisting of induction cooktop 220 and work surface 213. Three short cable portions 238a to 238c depart from a cooktop housing 230b that may contain a dual module for cooking. Each of cable portions 238a to 238c has a plug 239a to 239c at one end. An external induction coil 240 is arranged in a recess 218 of the work surface 213. A connecting lead 236 departs therefrom and is plugged onto the plug 239a with a socket fastened to the end thereof, i.e., is connected to it. As can be seen, two further external induction coils could also be connected to the cooktop housing 230b of the induction cooktop 220 via the other two plugs 239b and 239c. Thus, in a variant shown directly here, the cooktop housing 230b can supply up to three external induction coils. This would then be one more external induction coil than the very maximum number provided for the dual module in the cooktop housing 230b. Since this dual module can only drive two induction coils each differently and independently, it is therefore actually clear that switching between different external induction coils 240 and possibly also between at least one induction heating coil on the cooktop housing 230b itself must be carried out as described above by way of a relay switch or the like.

One readily conceivable variant may provide that one of the cable portions 238 is routed onward internally and is connected to the larger cooktop housing 230a and one of the converters or power splitters arranged therein. In turn, it can either be connected instead of an induction heating coil that is possible there, or alternatively be driven in alternation with such a coil by way of a stated relay switch.

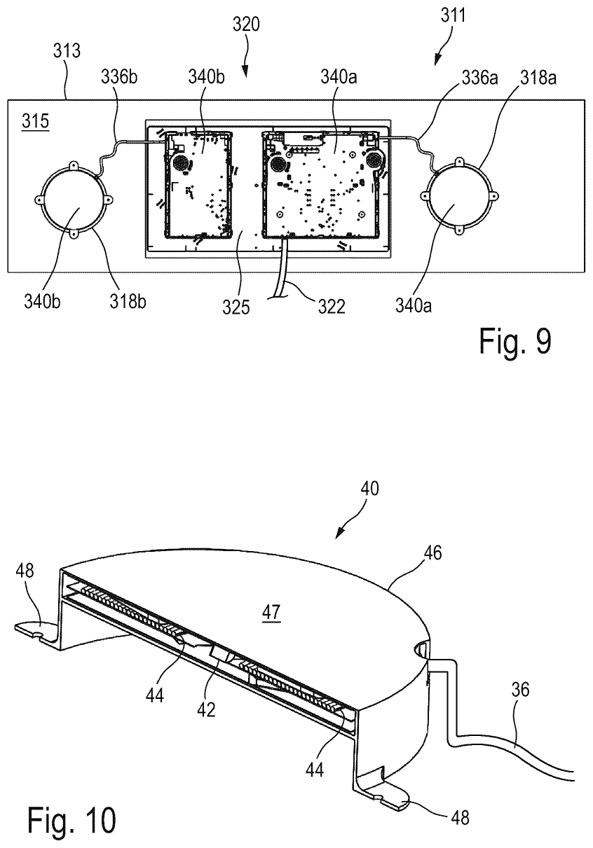

FIG. 9 shows or suggests a development corresponding to the above-stated alternative. The induction cooktop 320 has a large cooktop housing 340a and a small cooktop housing 340b, each configured with two dual modules and one dual module. The large cooktop housing 340a on the right is connected by way of a connecting lead 336 to a first external induction coil 340a that is arranged in the previously described manner next to it on an underside 315 of a work surface 313 of the system 311. The small cooktop housing 340b on the left is connected by a connecting lead 336b to an external induction coil 340b. This too is arranged in a recess 318b on the underside of the work surface.

The connecting leads 336a and 336b are, as for example explained in relation to FIGS. 5 and 6, fixedly wired or connected to the induction cooktop 320. They can either replace induction heating coils that may possibly be provided there or alternatively be provided in addition thereto. One of the two can then be driven for operation by way of a relay switch.

FIG. 10 is a detailed sectional view of how an external induction coil 40 may be constructed. The induction coil 40 has a winding body 44 that is wound spirally in a single layer from stranded coil wire. It can, for example, be arranged between micanite sheets and in a plastics coil housing 46. It is advantageously arranged relatively close to an upper side 47 of the coil housing 46. An above-stated temperature sensor 42 can also be provided here.

The coil housing 46 has four laterally protruding fastening portions 48 with which it can be screwed to the underside 15 of the work surface 13. The upper side 47 of the coil housing 46 should, if possible, rest against or be very close to the bottom of the recess 18. This recess 18 must be made in the work surface 13 in such a way that the induction coil 40 or winding body 44 is then at an exactly defined distance from the upper side 14 of the work surface 13. This is of great importance for use in inductive power transfer.

It is also shown how the connecting lead 36 is routed to the coil housing 46 from the side where it passes through an opening in the winding body 44. This connecting lead 36 can advantageously be an onwardly routed stranded coil wire of the winding body 44.

1. An induction cooktop having:
at least one induction heating coil for inductively heating an item of cookware arranged thereabove,
at least one external induction coil for inductive power transfer to an electrical consumer,
at least one power module including a converter for supplying power to said at least one induction heating coil and said at least one external induction coil,
a cooktop controller,
a cooktop plate,
an operating means,
a supply connection for supplying energy to said induction cooktop from an outside,
a cooktop housing in which said at least one power module is arranged, wherein said supply connection is arranged on or in said cooktop housing,
wherein:
said at least one induction heating coil is arranged within said cooktop housing or within said induction cooktop and beneath said cooktop plate,
a connecting lead is connected to said at least one power module,
said at least one external induction coil is connected to said connecting lead to be supplied with power by said power module and said converter therein,
said at least one external induction coil is configured to be installed outside said cooktop housing or said induction cooktop, wherein said at least one external induction coil is spatially separate from said induction cooktop,
said at least one external induction coil is configured for inductive power transfer to an electrical consumer, wherein said electrical consumer has a receiver coil, wherein said receiver coil is inductively couplable with said external induction coil.

2. The induction cooktop as claimed in claim 1, wherein said power module has connections for said at least one induction heating coil and a further additional connection, wherein said further additional connection is configured for electrical connection to said connecting lead and said connecting lead connected thereto is routed out of said cooktop housing, wherein a voltage converted by said power module or said converter is applied to said additional connection.

3. The induction cooktop as claimed in claim 2, wherein said connecting lead is detachably connected to said additional connection or is nondetachably connected to said additional connection.

4. The induction cooktop as claimed in claim 1, wherein as many connections are provided on said power module as there are said induction heating coils that are or may be arranged in said induction cooktop, wherein one of said induction heating coils is eliminated and said connecting lead for said external induction coil for inductive power transfer is connected to said electrical connection.

5. The induction cooktop as claimed in claim 1, wherein said connections take a form of a plug connection or of a screw connection.

6. The induction cooktop as claimed in claim 1, wherein said cooktop controller is configured to use said power supply to drive said external induction coil for inductive power transfer to said electrical consumer in such a way that a power request from said electrical consumer is transferable via said inductive coupling between said receiver coil and said external induction coil to said power module and to said cooktop controller where it is converted into a desired inductive power transfer to said electrical consumer by way of said external induction coil.

7. The induction cooktop as claimed in claim 1, wherein said external induction coil for inductive power transfer to said electrical consumer is arranged in a separate coil housing from said cooktop housing, wherein ferrite bodies are arranged in said coil housing beneath said induction coil.

8. The induction cooktop as claimed in claim 7, wherein said coil housing is without operating means.

9. The induction cooktop as claimed in claim 7, wherein said coil housing has provided thereon or therein an electrical connection means for said connecting lead, wherein said external induction coil is connected to said electrical connection means for inductive power transfer using a stranded coil wire and wherein said connecting lead is detachably connectable to said electrical connection means.

10. The induction cooktop as claimed in claim 7, wherein a connecting lead fixedly and nondetachably connected to said external induction coil leads away from said coil housing, wherein said connecting lead is or has an extended stranded coil wire of said external induction coil, wherein a free end of said connecting lead is configured to establish said electrical connection.

11. The induction cooktop as claimed in claim 1, wherein said external induction coil has a detection function or a sensor means being arranged thereon, wherein said detection function or said sensor means is permanently enabled so as to detect said electrical consumer being set down in order to be inductively supplied with power.

12. The induction cooktop as claimed in claim 11, wherein said external induction coil for inductive power transfer to said electrical consumer is arranged in a separate coil housing being separate from said cooktop housing, wherein a microcontroller is arranged in said coil housing for said external induction coil for evaluating said sensor means on said external induction coil in order to detect said electrical consumer being set down.

13. The induction cooktop as claimed in claim 1, wherein said connecting lead is a multicore connecting lead and has two conductors for transferring power and has two or three conductors for transferring data or signals or auxiliary voltages.

14. The induction cooktop as claimed in claim 1, wherein at least one switching means is provided in said power module in order to connect converted voltage from said converter either to a connected one said induction heating coil in said cooktop housing or to said connected external induction coil being arranged externally.

15. The induction cooktop as claimed in claim 1, wherein two connecting leads are routed out of said cooktop housing for connecting two said external induction coils for inductive power transfer.

16. The induction cooktop as claimed in claim 1, wherein said external induction coil is also configured for inductively heating cooking vessels arranged thereabove and is drivable accordingly.

17. The induction cooktop as claimed in claim 1, wherein at least one of said induction heating coils is configured for inductive power transfer to said electrical consumer.

18. The induction cooktop as claimed in claim 1, wherein it has two cooktop housings and a single common cooktop plate, wherein each said cooktop housing has one said power module including said converter, wherein only said induction heating coils are arranged in one said cooktop housing without a connection option for said external induction coil and wherein an additional connection is provided in said other cooktop housing for said external induction coil, wherein said additional connection is configured for an electrical connection to said connecting lead and said connecting lead connected thereto is routed out of said cooktop housing.

19. A system having an induction cooktop as claimed in claim 1 and a work surface, wherein said induction cooktop is arranged on said work surface, wherein said external induction coil is arranged under said work surface or under a further work surface of said system, wherein said external induction coil is connected to said induction cooktop by way of said connecting lead.

20. The system as claimed in claim 19, wherein said connecting lead is the only electrical and/or signal transfer connection of said external induction coil to an outside and/or to said induction cooktop, wherein said external induction coil is without an integrated power conversion.

21. The system as claimed in claim 19, wherein said external induction coil for inductive power transfer to said electrical consumer is arranged in a separate coil housing being separate from said cooktop housing, wherein said coil housing is fastened to said work surface from below.

22. The system as claimed in claim 21, wherein said work surface above said coil housing has a thickness being lesser in a recessed region than in other regions and is mechanically thinned by way of a blind hole or the like, and wherein said coil housing extends into said recessed region.

23. The system as claimed in claim 19, wherein, in a region in which said external induction coil is arranged, said work surface has a thickness of at most 12 mm, wherein said work surface consists of material being permeable to magnetic fields.

24. The system as claimed in claim 19, wherein said connecting lead is routed from said power module to a connection box being arranged outside said cooktop housing and being electrically connected thereto, wherein at least one said external induction coil for inductive power transfer is connected to said connection box, wherein said connection box is fastened to a support plate of said induction cooktop or to said work surface.

25. The system as claimed in claim 19, wherein a channel for said connecting lead is provided in said work surface, wherein said connecting lead runs within said channel and does not protrude from said channel or said work surface in said installed state, wherein said connecting lead is fastened in said channel by way of adhesive bonding, clamps, or other securing means.
